(19) United States
(12) Patent Application Publication
(10) Pub. No.: US 2022/0076313 A1
(43) Pub. Date: Mar. 10, 2022

(54) DYNAMIC PRODUCT AND PRODUCT REVIEW PRESENTATION BASED ON CANCELLATION AND RETURN PREDICTIVE ANALYTICS

(71) Applicant: INTERNATIONAL BUSINESS MACHINES CORPORATION, Armonk, NY (US)

(72) Inventors: Shikhar Kwatra, San Jose, CA (US); Raghuveer Prasad Nagar, Kota (IN); Jeremy R. Fox, Georgetown, TX (US); Jun Zhu, Cary, NC (US)

(21) Appl. No.: 16/948,221

(22) Filed: Sep. 9, 2020

(51) Int. Cl. G06Q 30/06; G06Q 30/02

(52) U.S. Cl. CPC G06Q 30/0627; G06Q 30/0282; G06Q 30/0617; G06Q 30/0643

(57) ABSTRACT

Embodiments of the present invention disclose a method, computer program product, and system for modifying a display of a product to emphasize feature that might cause a consumer to return a product. Receiving a new product that a consumer would like to view on a web browser on a consumer computing device and identifying at least one return feature about the new product that might cause the consumer to return the new product after it was purchased. Determining a return probability for the new product and determining, that the return probability is greater than or equal to a threshold value. Modifying a default product display for the new product to emphasize the identified at least one return feature of the new product.

### BACKGROUND

The present invention relates generally to the field of ecommerce, and more particularly to modifying a display of a product to emphasizing features that can cause the consumer to return the product.

Returns can cost as much as ten percent of sales revenue for a retailer. Online shoppers are more inclined to ignore product description and user reviews that do not fit their preferences and end up returning the products after receiving them. There are also those customers who abuse return policies with a return-after-use mindset. For example, a customer can order a dress, wear it the next day (after delivery/pickup), but return it after usage. A similar example of return policy abuse would be a customer who buys a product with a 30-day return policy, uses it for 25-days and still initiates a return. Retailers have countered return fraud with higher retail prices or tougher return polices, such as, “no receipt, not return,” “store credit regardless of the form of the tender used to purchase,” and “restocking fees” policies. Fraudulent returns of products by consumers is a problem, but many returns initiated by the consumer are caused by the consumer not reviewing the details of the product prior to purchase.

### BRIEF SUMMARY

Additional aspects and/or advantages will be set forth in part in the description which follows and, in part, will be apparent from the description, or may be learned by practice of the invention.

Embodiments of the present invention disclose a method, computer program product, and system for modifying a display of a product to emphasize feature that might cause a consumer to return a product. Receiving a new product that a consumer would like to view on a web browser on a consumer computing device and identifying at least one return feature about the new product that might cause the consumer to return the new product after it was purchased. Determining a return probability for the new product and determining, that the return probability is greater than or equal to a threshold value. Modifying a default product display for the new product to emphasize the identified at least one return feature of the new product.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a functional block diagram illustrating an ecommerce processing environment, in accordance with an embodiment of the present invention.

FIG. 2 is a flowchart depicting operational steps of modifying a product display within the ecommerce processing environment of FIG. 1, in accordance with an embodiment of the present invention.

FIG. 3 is a block diagram of components of a computing device of the ecommerce processing environment of FIG. 1, in accordance with embodiments of the present invention.

FIG. 4 depicts a cloud computing environment according to an embodiment of the present invention.

FIG. 5 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Reference will now be made in detail to the embodiments of the present invention, examples of which are illustrated in the accompanying drawings, wherein like reference numerals refer to like elements throughout. Embodiments of the invention are generally directed to a system for ecommerce, more particularly, modifying an online product display to emphasize features of the product that might cause the consumer to return the product after purchase. A product can be returned by a consumer for a variety of reason, for example, dimensions of the product (e.g. furniture), product does not fit (e.g. clothing), change of mind, features of the product the consumer does not like, or a variety of other reasons. An increase in the amount of returns causes the cost of the retailers to increase. Most retailers have focused on penalizing a consumer who returns a product, such as, a restocking fees or store credit only. However, retailers have not instituted practices to inform consumers that they might not like certain features of a product prior to purchase based on the probability that the consumer will return the product after purchase. A way to reduce the number of product returns is by emphasizing in the product display the features that might cause the consumer to return the product. The ecommerce server has a default product display for each product in their inventory and the ecommerce server modifies the default display, for example, by change the order of images of the product, rearranging the text of the features, changing the format of the text (e.g. color, font, highlighting, or size) to emphasize the feature, highlighting or other text modification to the user reviews/comments, or other possible modifications to emphasize product features the consumer might not like. The goal of the modification is to bring the features of the product that might cause the consumer to return the product to the attentions of the consumer. When the consumer is aware of these features, then consumer can make an informed decision as to purchase the product or not.

The modification is determined by analyzing the consumer purchase history, shopping history, return history, and any comments/reviews the consumer has made. The analysis can show that the consumer does not like certain features, for example, the consumer might not like wood soles on shoes, certain fabrics, dimension of products, etc. . . . The consumer could have a higher return rate based on their shopping history. The consumer shopping history is referring to how the consumer goes about looking for products, e.g. does the consumer look for a specific product based on a search query, clicking on the sales tab, deals of the day tab, looking at related items, etc. By analyzing the consumer profile, the ecommerce server can identify which features the consumer does not like. Therefore, when the consumer is looking at a new product the ecommerce server can determine the probability the consumer will return the product if the consumer purchased the product. If the return probability is greater than or equal to a threshold value, then the ecommerce server modifies the default product layout to emphasize the features that might lead the consumer to return the product.

Different products offered by the ecommerce store will have different return histories. The ecommerce store can identify different features of the product that consumers do not like based on the reasons why different consumers return the product. The ecommerce store reviews any comments/reviews provided by consumers to identify features that consumers do not like about the product. By analyzing the product history the ecommerce server is able to identify which features of product that the consumer did not like, so when a new consumer is looking at the product the ecommerce server is able to determine the probability the new consumer will return the product. The ecommerce server takes into consideration the specific consumer history and the history of the specific product to identify features that might cause the return of the product. The ecommerce store modifies the display of the product to emphasize the identified features.

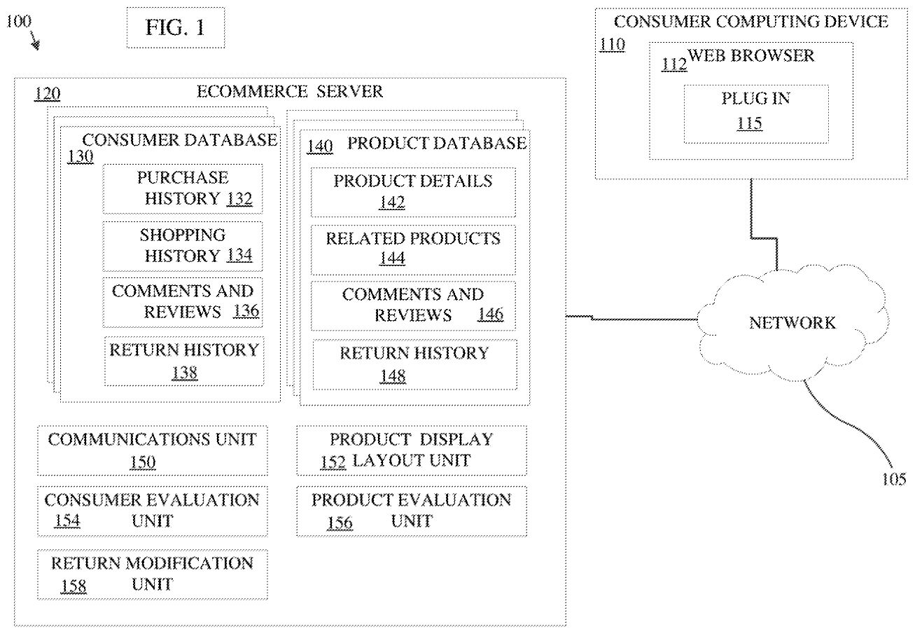

FIG. 1 is a functional block diagram illustrating an ecommerce processing environment 100, in accordance with an embodiment of the present invention.

Network 105 can be, for example, a local area network (LAN), a wide area network (WAN) such as the Internet, or a combination of the two, and can include wired, wireless, or fiber optic connections. In general, network 105 can be any combination of connections and protocols that will support communications between the consumer computing device 110 and ecommerce server 120.

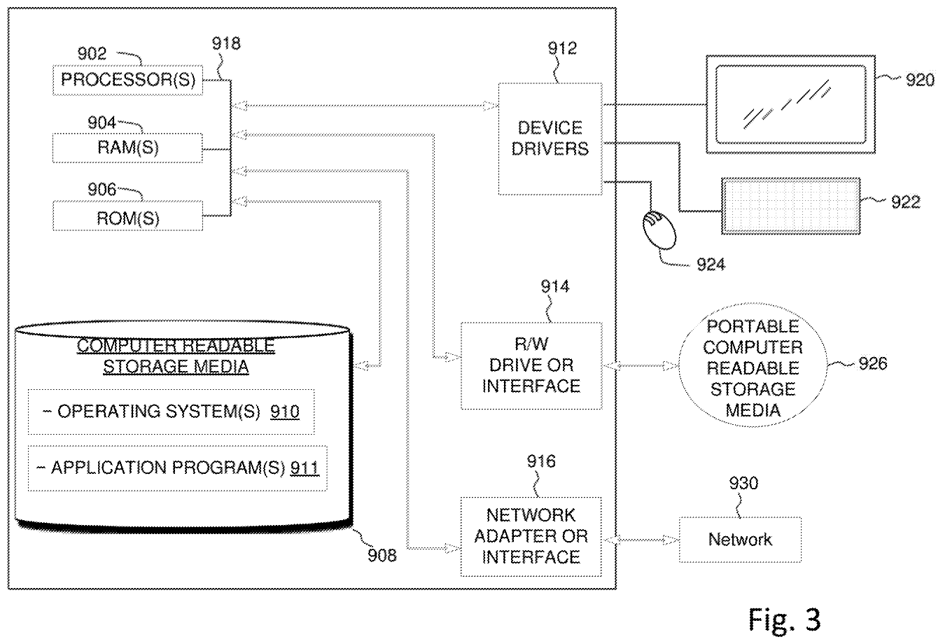

The consumer computing device 110 may be a laptop computer, tablet computer, netbook computer, personal computer (PC), a desktop computer, a personal digital assistant (PDA), a smart phone, or any programmable electronic device capable of communicating with ecommerce server 120, via the network 105. The consumer computing device 110 may include internal and external hardware components, as depicted, and described in further detail with respect to FIG. 3.

The consumer computing device 110 includes web browser 112 that allows the consumer to view different websites and/or ecommerce sites. When viewing an ecommerce site, a consumer clicks on a product to view and the web browser 112 displays the details about the product. The display of the product in web browser 112, can include, for example, multiple images of the product, important features section (features about the product that should be emphasized), product details (e.g. features, dimensions, function, material), alternative embodiments of the product (dimension variations, color variations, motorized variations, material variations, or other variations), reviews and comments from previous consumers who have purchased the product, related products, or other information about the product. The ecommerce server 120 contains the information about the product and how the product should be displayed and sends that data to the consumer computing device 110 to be displayed in the web browser 112. The web browser 112 can have a plugin 115 that could contain personal information about the consumer, since the plugin 115 is contained within the consumer computing device 110, then the consumer personal data is not exposed to outside sources. The plugin 115 can be designed to modify the product display in the web browser 112 based on the analysis of the consumer information that will be described in further detail below.

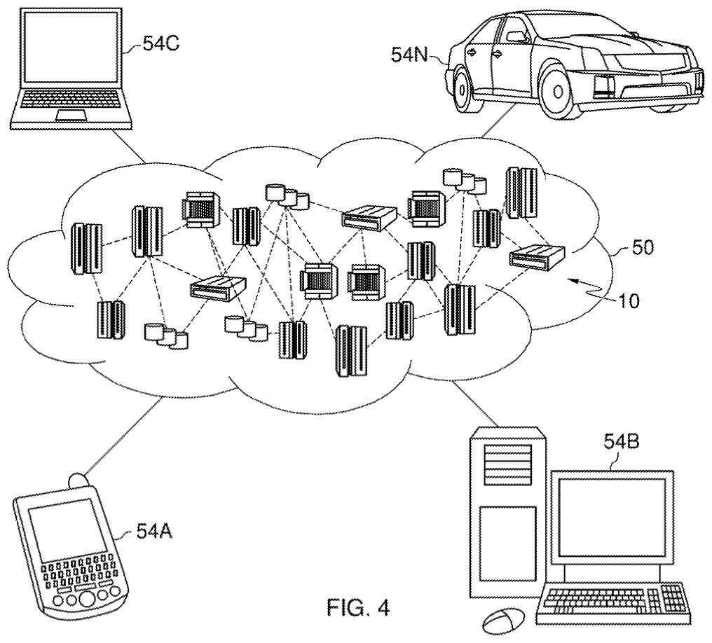

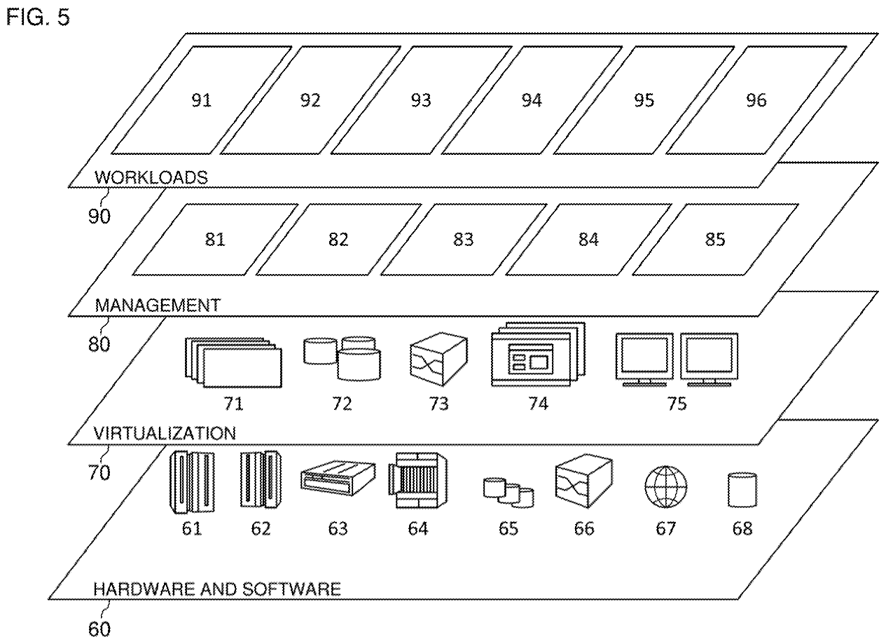

The ecommerce server 120 includes a consumer database 130, a product database 140, a communications unit 150, a product display layout unit 152, a consumer evaluation unit 154, a product evaluation unit 156, and a return modification unit 158. The ecommerce server 120 may include internal and external hardware components, as depicted, and described in further detail below with respect to FIG. 3, and operate in a cloud computing environment, as depicted in FIGS. 4 and 5.

The consumer database 130 is a data store that stores data relating to the consumer, for example, data relating to the consumer includes purchase history 132, shopping history 134, comments and reviews 136, and return history 138. The purchase history 132 keeps tracks of the previous products the consumer has purchased. The shopping history 134 tracks how the consumer shops on the ecommerce store, for example, the consumer could search for a specific product using a search query, the consumer could click on deals of the days to browse and purchase items, the consumer could search the related products shown in another product display, the consumer could search a sales section, or any other way the consumer could shop on the ecommerce site. The shopping history 134 tracks how the consumer shops and tracks which shopping method leads to the consumer purchasing a product. The comments and reviews 136 track and store the comments and reviews the consumer leaves on products. The return history 138 tracks the products (the specific product and type of product) the consumer has returned and tracks the reason given by the consumer for returning the products.

The product database 140 is a data store that stores data relating to product details 142, related products 144, comments and reviews 146, and return history 148. The product details 142 stores data relating to all the features, images, and details relating to every product that the ecommerce store has available for consumer purchase. The related products 144 identifies which products are related to each other, the related products are identified by consumer purchase and/or by an administrator. The comments and reviews 146 track any comments or reviews a consumer has submitted for each product. The return history 148 tracks the returns for each product and the reasons why a consumer has returned the product.

The communications unit 150 facilities communications between the ecommerce server 120 and the consumer computing device 110 via the network 105.

The product display layout unit 152 arranges a default layout for each product. The default layout includes a default arrangement the images relating to the product, a default arrangement of product details, a default arrangement of key product features, a default arrangement of consumer comments and reviews, a default arrangement of related products, and a default arrangement of any other information relating to the product.

The consumer evaluation unit 154 analyzes the data stored within the consumer database 130 to determine the reasons why a specific consumer might return a product. The consumer evaluation unit 154 analyzes the return history 138 to determine the reasons why the customer returned the products. The consumer evaluation unit 154 determines if the customer has returned a type of products (e.g. kitchen appliances) more than other types (e.g. audio equipment) and the reason why the products were returned. The consumer evaluation unit 154 links the returned products in the return history 138 to the shopping method in the shopping history 134 to determine which shopping method leads to the consumer returning more products. The consumer evaluation unit 154 analyzes any comments and reviews 136 that the consumer has posted to determine the features that the consumer might not like. The consumer evaluation unit 154 utilizes a natural language process to analyze the consumer comments and reviews 136 to identify which features the consume does not like about any product they commented on. The consumer evaluation unit 154 analyzes a specific consumer to determine reasons why the specific consumer would return a product, but the product evaluation unit 156 analyzes a specific product for reasons why consumers have returned that specific product.

The product evaluation unit 156 analyzes the data stored within the product database 140 to determine the reasons why consumers returned a specific product. The product evaluation unit 156 analyzes the return history 148 for the specific product to determine why consumers have returned the specific product. The product evaluation unit 156 links the determined reason why the consumer returned the specific product to the details stored in the product details 142. For example, if a consumer returned the specific product giving the reason that it was too large, then the product evaluation unit 156 would determine that the dimensions in the product details 142 was reason the consumer returned the product. The product evaluation unit 156 analyzes any comments and reviews 146 that consumers have posted relating to the specific product to determine which features of the specific product that consumers might not like. The product evaluation unit 156 utilizes a natural language process to analyzes the consumer comments and reviews 146.

When a consumer clicks on a new product to view in their web browser 112 then the return modification unit 158 determines the probability that the specific consumer might return the new product (the product the consumer clicked on) if the consumer would purchase the new product. The return modification unit 158 aggregates the determined reasons why a specific consumer would return the new product from the consumer evaluation unit 154 and the product evaluation unit 156. The return modification unit 158 reviews the aggregated data from the consumer evaluation unit 154 and the product evaluation unit 156 with respect to the new product clicked on to determine the specific consumer return probability with respect to the new product. For example, when the new product the consumer wants to view is a specific television (or any other product), then the return modification unit 158 receives data containing the number of televisions the specific consumer has returned and why the specific consumer returned those televisions from the consumer evaluation unit 154. The return modification unit 158 receives data about how many times consumers have returned the specific electronic device (e.g. the specific television) and the reason why the specific electronic device was returned from the product evaluation unit 156. The return evaluation unit 158 determines a return probability for the consumer regarding the specific product the user clicked on and compares the return probability to a threshold value.

When the return probability is below the threshold value then the return modification unit 158 does not change the default layout of the product as determined by the product display layout unit 152. When the return probability is greater than or equal to the threshold value then the return modification unit 158 modifies the display on the product the consumer clicked on. For example, the return modification unit 158 can change the order/arrangement of the images of the products to emphasize images that show features that would cause the consumer to return the product. The return modification unit 158 can add features (details) to the important feature section, where the added features illustrate features that can cause the specific consumer to return the product, and/or added features illustrate the reasons why other consumer have returned the product. The return modification unit 158 can further modify the text of these added features to further emphasize them. The return modification unit 158 could change the color, font style, size of the text, format of the text, or by highlighting the text to further emphasize the added feature that might cause the product to be returned. The return modification unit 158 can further modify the details section of the product, by rearranging the details, emphasizing certain details by changing the color, font style, size of the text, format of the text, or highlighting the text. The return modification unit 158 can modify the display of the comments and reviews associated with the product in order to emphasize the comments and reviews that show reasons why the product was returned by consumers or detail reasons similar to the reason why the consumer has returned products. The return modification unit 158 can modify the color, font style, size of the text, format of the text, or by highlighting the text of the review or comments. The return modification unit 158 modifies the display of the product in the web browser 112 on the consumer computing device 110.

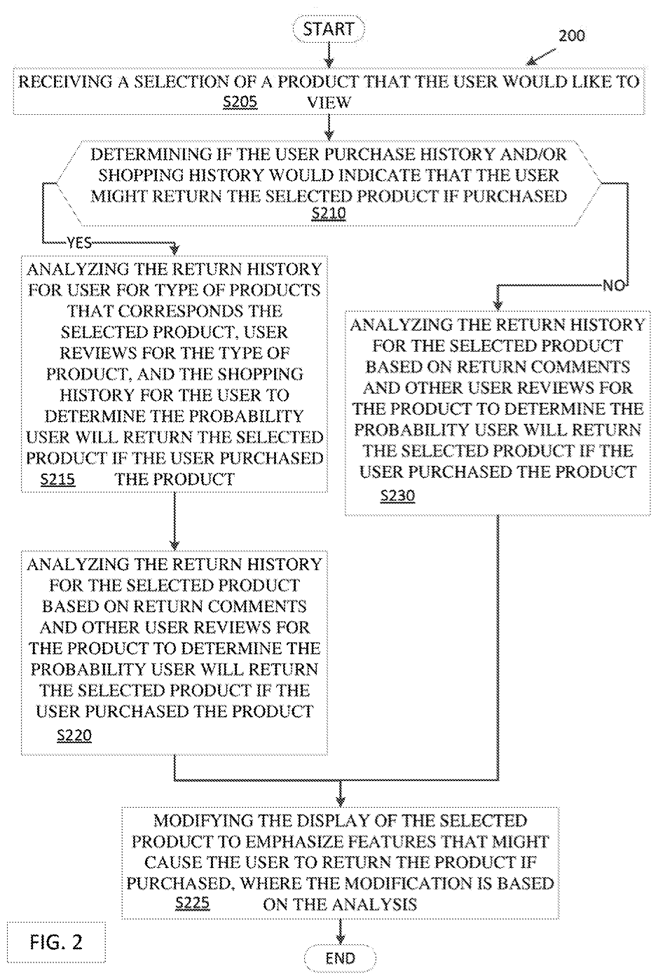

FIG. 2 is a flowchart depicting operational steps of modifying a product display within the ecommerce processing environment 100 of FIG. 1, in accordance with an embodiment of the present invention.

The ecommerce server 120 receives the data the consumer would like to view a specific product, for example, if the consumer clicks on the product the ecommerce server 120 receives the identity of the specific product the consumer wants to view (S205). The ecommerce server 120 determines if the consumer has a consumer profile stored in the consumer database 140 (S210). The ecommerce server 120 can associated the consumer with a specific consumer profile by having the consumer sign into the ecommerce store.

When the ecommerce server 120 determines that the consumer has a stored profile, then the consumer evaluation unit 154 analyzes the consumer shopping history, purchase history, review and comment, and return history to determine the reasons why the consumer might return the specific product the consumer clicked on to view (S215). The consumer evaluation unit 154 analyzes the return history 138 to determine the reasons why the customer returned similar types of products as the specific product the consumer wants to view. The consumer evaluation unit 154 determines if customer has returned a type of products more than other types of products and the reason why the products were returned. The consumer evaluation unit 154 links the returned products, stored in the return history 138, to the shopping method, stored in the shopping history 134 to determine which shopping methods utilized by the consumer lead to the consumer returning more products. The consumer evaluation unit 154 analyzes any comments and reviews 136 that the consumer has posted to determine the features that the consumer might not like. The consumer evaluation unit 154 utilizes a natural language processing to analyze the consumer comments and reviews 136. The consumer evaluation unit 154 aggregates all the determined reasons why a specific consumer might return the product the consumer clicked on to view (S215).

The product evaluation unit 156 analyzes the data contained within the product database 140 to determine the reasons why consumers (who have previously purchased) returned the specific product the consumer clicked on to view (S220). The product evaluation unit 156 analyzes the return history 158 for the specific product to determine the reasons why consumers have returned the specific product. The product evaluation unit 156 links the determined reasons why the consumers returned the specific product to the details stored in the product details 142. For example, if the consumers have returned the specific product and giving the reason for returned was that the specific product was too large, then the product evaluation unit 156 would determine that the dimensions in the product details 142 was the reason the consumers returned the product. The product evaluation unit 156 analyzes any comments and reviews 146 that consumer have posted relating to the specific product to determine the features of the specific product that consumers might not like. The product evaluation unit 156 utilizes a natural language process to analyze the consumer comments and reviews 146. The product evaluation unit 156 aggregates all the determined reason why the consumer might return the product the consumer clicked on to view (S220).

The return modification unit 158 reviews the results from the consumer evaluation unit 154 (S215) and the product evaluation unit 156 (S220) with respect to the specific product the consumer clicked on to view to determine the return probability for the product (S225). For example, when the new product the consumer wants to view is a specific television (or any other product), then the return modification unit 158 receives data containing the number of televisions the specific consumer has returned and why the specific consumer returned those televisions from the consumer evaluation unit 154. The return modification unit 158 receives data about how many times consumers have returned the specific electronic device (e.g. the specific television) and the reason why the specific electronic device was returned from the product evaluation unit 156. The return evaluation unit 158 determines a return probability for the consumer regarding the specific product the user clicked on and compares the return probability to a threshold value (S225).

When the return probability is below the threshold value then the return modification unit 158 does not change the default layout of the product as determined by the product display layout unit 152. When the return probability is greater than or equal to the threshold value then the return modification unit 158 modifies the display on the product that consumer clicked on to emphasize reasons why the consumer might return the product (S225). For example, the return modification unit 158 can change the order/arrangement of the images of the products to emphasize images that show features that would cause the consumer to return the product. The return modification unit 158 can add features (details) to the important feature section, where the added features illustrate features that can cause the specific consumer to return the product, and/or added features illustrate the reasons why other consumer have returned the product. The return modification unit 158 can further modify the text of these added features to further emphasize them. The return modification unit 158 could change the color, font style, size of the text, format of the text, or by highlighting the text to further emphasize the added feature that might cause the product to be returned. The return modification unit 158 can further modify the details section of the product, by rearranging the details, emphasizing certain details by changing the color, font style, size of the text, format of the text, or highlighting the text. The return modification unit 158 can modify the display of the comments and reviews associated with the product in order to emphasize the comments and reviews that show reasons why the product was returned by consumers or detail reasons similar to the reason why the consumer has returned products. The return modification unit 158 can modify the color, font style, size of the text, format of the text, or by highlighting the text of the review or comments. The return modification unit 158 modifies the display of the product in the web browser 112 on the consumer computing device 110 (S225).

When the consumer is not known by the ecommerce server 120, then the product evaluation unit 156 analyzes the data contains within the product database 140 to determine the reasons why consumers (who have previously purchased) returned the product the consumer clicked on to view (S230), which is the same process as step S220 as described above. The return modification unit 158 reviews the results from the product evaluation unit 156 (S220) determines the return probability for the product for product the consumer wants to view based on data from the product evaluation unit (S225). The return evaluation unit 156 modifies the display of the specific product, as described above, in the web browser 112 based on the determined return reasons from the product evaluation unit 156 (S225).

FIG. 3 depicts a block diagram of components of consumer computing device 110 and the ecommerce server 120 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

The ecommerce server 120 and the consumer computing device 110 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications, and network processors, etc.), system memory, peripheral devices, and any other hardware components within a system.

One or more operating systems 910, and one or more application programs 911, for example, return modification unit 158 (FIG. 1), are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The ecommerce server 120 and the consumer computing device 110 may also include a R/W drive or interface 914 to read from and write to one or more portable computer readable storage media 926. Application programs 911 on the ecommerce server 120 and the consumer computing device 110 may be stored on one or more of the portable computer readable storage media 926, read via the respective R/W drive or interface 914 and loaded into the respective computer readable storage media 908.

The ecommerce server 120 and the consumer computing device 110 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the ecommerce server 120 and the consumer computing device 110 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

The ecommerce server 120 and the consumer computing device 110 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and return modification unit 96.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

1. A method for modifying a product display in an ecommerce store, the method comprising:
receiving, by a computer, a new product that a consumer would like to view on a web browser on a consumer computing device;
identifying, by the computer a plurality of return features about the new product that might cause the consumer to return the new product after it was purchased, wherein the plurality of return features is determined from analyzing a user profile and from analyzing the return history for the new product, wherein the analyzing of the user profile identifies features that caused the user to return a previous product that is related to the new product, wherein the analyzing the return history of the new products comprises identify at least one feature that caused the new product to be previously returned;
determining, by the computer, a return probability for the new product, wherein the returned probability is based on the identified plurality of return features;
determining, by the computer, that the return probability is greater than or equal to a threshold value; and
modifying, by the computer, a default product display for the new product to emphasize the identified the plurality of return features of the new product, wherein the modifying a default product displaying includes adding one return feature of the plurality of return features to an important features section in the default product display of the new product, wherein the added return feature was not included in default content of the important features section of the default product display.

2. The method of claim 1, wherein analyzing the user profile comprises:
analyzing, by the computer, a first profile associated with the consumer to identify product features that has previously caused the consumer to return products, wherein the first profile includes a consumer purchase history, a shopping history, a comments and reviews, and a return history.

3. The method of claim 2, wherein identifying the plurality of return features comprises:
analyzing, by the computer, a second profile associated with the new product to identify product features that has caused previous customer who have purchased the new product to return the new product, wherein the second profile includes a product details, a return history for the new product, and a comments and reviews provided by users.

4. The method of claim 3, wherein the determining the return probability for the new product is based on the analysis of the first profile and the second profile.

5. The method of claim 1, wherein the modifying the default product display comprises:
rearranging, by the computer, a default layout of images corresponding to the new product by changing the order of the images to emphasize one return feature of the plurality of return features.

6. (canceled)

7. The method of claim 1, wherein the added return feature is a different color than the other features in the important features section.

8. The method of claim 1, wherein the modifying the default product display comprises:
emphasizing, by the computer, at least one review on the new product display, wherein the at least one review correlates to one return feature of the plurality of return, wherein the emphasizing comprises highlighting the at least one review.

9. A computer program product for modifying a product display in an ecommerce store, the computer program product comprising:
one or more non-transitory computer-readable storage media and program instructions stored on the one or more non-transitory computer-readable storage media, the program instructions comprising:
program instructions to receive a new product that a consumer would like to view on a web browser on a consumer computing device;
program instructions to identify a plurality of return features about the new product that might cause the consumer to return the new product after it was purchased, wherein the plurality of return features is determined from analyzing a user profile and from analyzing the return history for the new product, wherein the analyzing of the user profile identifies features that caused the user to return a previous product that is related to the new product, wherein the analyzing the return history of the new products comprises identify at least one feature that caused the new product to be previously returned;
program instructions to determine a return probability for the new product, wherein the returned probability is based on the identified plurality of return features;
program instructions to determine that the return probability is greater than or equal to a threshold value; and
program instructions to modify a default product display for the new product to emphasize the identified the plurality of return features of the new product, wherein the modifying a default product displaying includes adding one return feature of the plurality of return features to an important features section in the default product display of the new product, wherein the added return feature was not included in default content of the important features section of the default product display.

10. The computer program product of claim 9, wherein the program instructions to analyze the user profile comprises:
program instructions to analyze a first profile associated with the consumer to identify product features that has previously caused the consumer to return products, wherein the first profile includes a consumer purchase history, a shopping history a comments and reviews, and a return history.

11. The computer program product of claim 10, wherein the program instructions to identify the plurality of return features comprises:
program instructions to analyze a second profile associated with the new product to identify product features that has caused previous customer who have purchased the new product to return the new product, wherein the second profile includes a product details, a return history for the new product, and a comments and reviews provided by users.

12. The computer program product of claim 11, wherein the program instructions to determine the return probability for the new product is based on the analysis of the first profile and the second profile.

13. The computer program product of claim 9, wherein the program instructions to modify the default product display comprises:
program instructions to rearrange a default layout of images corresponding to the new product by changing the order of the images to emphasize one return feature of the plurality of return features.

14. (canceled)

15. The computer program product of claim 9, wherein the added the one return feature is a different color than the other features in the important features section.

16. The computer program product of claim 9, wherein the program instructions to modify the default product display comprises:
program instructions to emphasize at least one review on the new product display, wherein the least one review correlates to one return feature of the plurality of return features, wherein the emphasizing comprises highlighting the at least one review.

17. A computer system for modifying a product display in an ecommerce store, the computer system comprising:
one or more computer processors, one or more computer-readable storage media, and program instructions stored on the one or more of the computer-readable storage media for execution by at least one of the one or more processors, the program instructions comprising:
program instructions to receive a new product that a consumer would like to view on a web browser on a consumer computing device;
program instructions to identify a plurality of return features about the new product that might cause the consumer to return the new product after it was purchased, wherein the plurality of return features is determined from analyzing a user profile and from analyzing the return history for the new product, wherein the analyzing of the user profile identifies features that caused the user to return a previous product that is related to the new product, wherein the analyzing the return history of the new products comprises identify at least one feature that caused the new product to be previously returned;
program instructions to determine a return probability for the new product, wherein the returned probability is based on the identified plurality of return features;
program instructions to determine that the return probability is greater than or equal to a threshold value; and
program instructions to modify a default product display for the new product to emphasize the identified the plurality of return features of the new product, wherein the modifying a default product displaying includes adding one return feature of the plurality of return features to an important features section in the default product display of the new product, wherein the added return feature was not included in default content of the important features section of the default product display.

18. The computer system of claim 17, wherein the program instructions to analyze the user profile comprises:
program instructions to analyze a first profile associated with the consumer to identify product features that has previously caused the consumer to return products, wherein the first profile includes a consumer purchase history, a shopping history, a comments and reviews, and a return history.

19. The computer system of claim 18, wherein the program instructions to identify the plurality of return features comprises:
program instructions to analyze a second profile associated with the new product to identify product features that has caused previous customer who have purchased the new product to return the new product, wherein the second profile includes a product details, a return history for the new product, and a comments and reviews provided by users.

20. The computer system of claim 19, wherein the program instructions to determine the return probability for the new product is based on the analysis of the first profile and the second profile.
